(19) United States
(12) Patent Application Publication
(10) Pub. No.: US 2008/0162129 A1
(43) Pub. Date: Jul. 3, 2008

(54) METHOD AND APPARATUS PERTAINING TO THE PROCESSING OF SAMPLED AUDIO CONTENT USING A MULTI-RESOLUTION SPEECH RECOGNITION SEARCH PROCESS

(75) Inventor: Yan Ming Cheng, Inverness, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/617,908

(22) Filed: Dec. 29, 2006

(51) Int. Cl. G10L 15/00

(52) U.S. Cl. 704/231; 704/256; 704/E15.02

(57) ABSTRACT

One provides (101) a plurality of frames of sampled audio content and then processes (102) that plurality of frames using a speech recognition search process that comprises, at least in part, searching for at least two of state boundaries, subword boundaries, and word boundaries using different search resolutions.

### RELATED APPLICATIONS

This application is related to a U.S. application being filed on the same date, having attorney docket number CML040301HI, entitled METHOD AND APPARATUS PERTAINING TO THE PROCESSING OF SAMPLED AUDIO CONTENT USING A FAST SPEECH RECOGNITION SEARCH PROCESS, having inventor Yan Ming Cheng, and assigned to the assignee hereof. The USASN of the related application is unknown at this time.

### TECHNICAL FIELD

This invention relates generally to speech recognition processes and more particularly to speech recognition search processes.

### BACKGROUND

Speech recognition comprises a known area of endeavor. Certain speech recognition processes make use of speech recognition search processes such as, but not limited to, the so-called hidden Markov model-based speech recognition process. This generally comprises use of a statistical model that outputs a sequence of symbols or quantities where speech is essentially treated as a Markov model for stochastic processes commonly referred to as states. An exemplary hidden Markov model might output, for example, a sequence of 39-dimensional real-valued vectors, outputting one of these about every 10 milliseconds.

Such vectors might comprise, for example, cepstral coefficients that are obtained by taking a Fourier transform of a short-time window of sampled speech and de-correlating the spectrum using a cosine transform, then taking the first (most significant) coefficients for these purposes. The hidden Markov model approach will tend to have, for each state, a statistical distribution called a mixture of diagonal or full covariance Gaussians that will characterize a corresponding likelihood for each observed vector.

In many prior art approaches, a conventional speech recognition search requires that boundaries between words, subwords, and the aforementioned states be searched on a regular basis (typically per each frame of sampled audio content) using a single level of resolution. Though indeed an optimal and powerful approach, this frame-by-frame (or single resolution) approach to searching for word, subword, and state boundaries also requires considerable computational resources. This need only grows with the depth and richness of the supported vocabulary. As a result, a speech recognition process that employs a speech recognition search process can require enormous computational resources.

Consider, for example, an application setting where each frame represents only about 10 milliseconds of audio content. For a speech recognition process that supports recognition of, say, 50,000 words, it then becomes necessary to search and compare the recognition data as corresponds to each of those 50,000 words for each such frame. This, alone, can require considerable computational capability. These requirements only grow more severe as one considers that such a process also requires a corresponding search for subwords with each such frame.

As a result, such an approach, while often successful to carry out optimal speech recognition, is also often too computationally needy to work well in an application setting where such computational overhead is simply not available. Small, portable, wireless communications devices such as cellular telephones and the like, for example, represent such an application setting. Both available computational capability as well as corresponding power capacity limitations can severely limit the practical usage of such an approach.

### BRIEF DESCRIPTION OF THE DRAWINGS

The above needs are at least partially met through provision of the method and apparatus pertaining to the processing of sampled audio content using a speech recognition search process described in the following detailed description, particularly when studied in conjunction with the drawings, wherein:

FIG. 1 comprises a flow diagram as configured in accordance with various embodiments of the invention;

FIG. 2 comprises a schematic diagram as configured in accordance with various embodiments of the invention; and

FIG. 3 comprises a block diagram representation as configured in accordance with various embodiments of the invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

Generally speaking, pursuant to these various embodiments, one provides a plurality of frames of sampled audio content and then processes that plurality of frames using a speech recognition search process that comprises, at least in part, searching for at least one of state boundaries at a base resolution, for example, within each frame, searching for at least two of state boundaries, subword boundaries, and word boundaries using different search resolutions. This contrasts sharply with present practice, of course, in that present practice will typically require systematically searching each frame (or at single resolution) for each state, subword, and word boundaries.

This can comprise, by one approach, using a first relatively fine level of search resolution (such as each and every frame) when searching for state boundaries and a coarser level of resolution (such as every other frame) when searching for sub-word and word boundaries. As another example, this can comprise, by one approach, using a first relatively fine level of search resolution (such as each and every frame) when searching for state boundaries, a coarser level of resolution (such as every other frame) when searching for sub-word boundaries, and an even courser level of resolution (such as every fourth frame) when searching for word boundaries.

So configured, these teachings permit relatively accurate and high quality speech recognition processing as one might ordinarily expect when using such speech recognition search processes while nevertheless avoiding a considerable amount of computational activity. By skipping some frames in this regard, the processing platform can be significantly relieved of the corresponding computational support. This, in turn, permits a given processing platform having only modest capacity and/or capability to nevertheless often carry out a speech recognition search process with successful results.

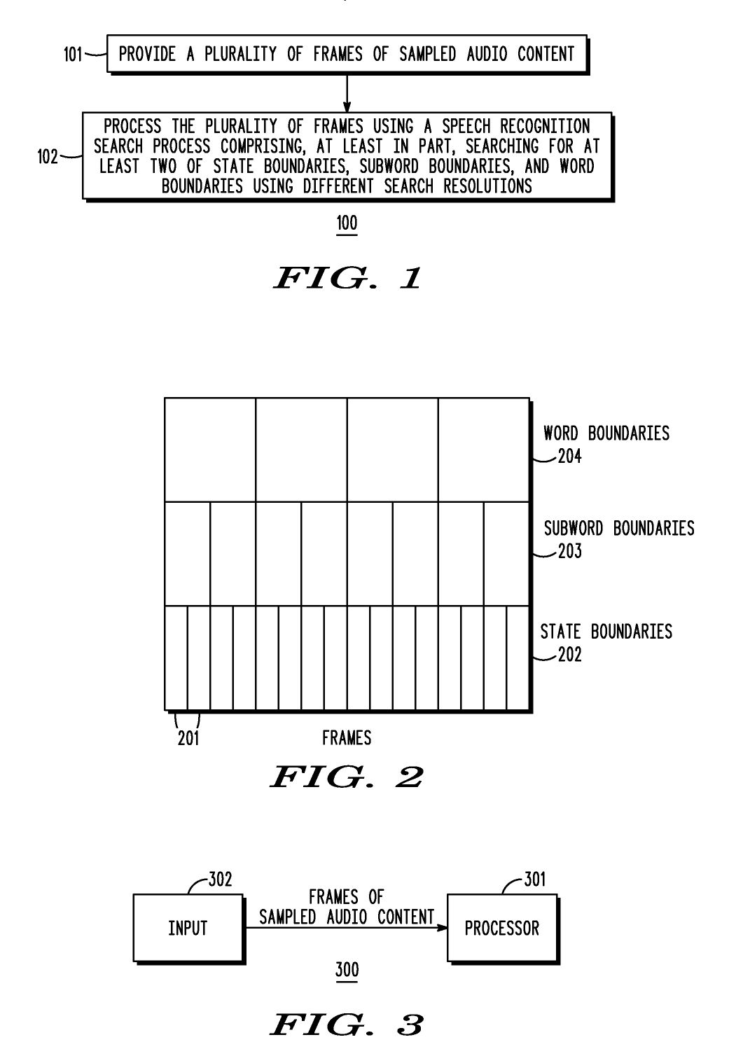

These and other benefits may become clearer upon making a thorough review and study of the following detailed description. Referring now to the drawings, and in particular to FIG. 1, an exemplary process 100 that accords with these teachings first provides 101 a plurality of frames of sampled audio content and then provides for processing 102 those frames using a speech recognition search process that comprises, at least in part, searching for at least two of states boundaries, subword boundaries, word boundaries using different search resolutions. There are various known processes by which such frames can be captured and provided and other processes in this regard are likely to be developed in the future. As these teachings are not overly sensitive to the selection of any particular approach in this regard, for the sake of brevity as well as the preservation of narrative focus further elaboration regarding the provision of such frames will not be provided here save to note that such frames typically only correspond to a relatively brief period of time such as, but not limited to, 10 milliseconds.

The above-mentioned speech recognition search process can comprise such processes as may be suitable to meet the needs of a given application setting. For the purposes of providing an illustrative example and not by way of limitation it will be presumed herein that this speech recognition search process comprises a hidden Markov model-based speech recognition process.

By one approach, this step 102 can comprise searching for each of state boundaries, subword boundaries, and word boundaries using a base resolution, secondary resolution, and third resolution, respectively that are each different from one another. This can comprise, for example, searching for state boundaries for every frame, only searching for subword boundaries for every Nth frame (where N comprises an integer larger than one) and only searching for word boundaries for every Mth frame (where M comprises an integer equal to or larger than N and, more particularly, may comprise an integer that comprises a multiple of N).

To illustrate, consider the schematic representation shown in FIG. 2 (where those skilled in the art will recognize and understand that the example provided is intended to server only in an illustrative capacity and is not intended to comprise an exhaustive offering of all possibilities in this regard). In this example, the speech recognition processing includes searching for state boundaries 202 in each frame 201. Subword boundaries 203, however, are only searched for every other frame (i.e., N=2) and word boundaries 204 are only searched for every fourth frame (i.e., M=4 which also comprises, as suggested above, a multiple of N).

So configured, those skilled in the art will recognize and appreciate that the overhead requirements associated with subword boundary searching is halved and the overhead requirements associated with word boundary searching is reduced by 75%. This, of course, represents a considerable reduction in computational requirements and makes such a speech recognition search process available to a greatly increased population of platforms including, for example, cellular telephones and the like.

Those skilled in the art will recognize that greater savings in this regard are achieved by increasing the number of skipped frames. Such an increase, however, at some point may reduce the overall quality of the speech recognition process. The appropriate settings to apply in a given situation may change with the application setting as the designer strikes a satisfactory compromise between the quality of the resultant output and corresponding computational requirements.

Those skilled in the art will appreciate that the above-described processes are readily enabled using any of a wide variety of available and/or readily configured platforms, including partially or wholly programmable platforms as are known in the art or dedicated purpose platforms as may be desired for some applications. Referring now to FIG. 3, an illustrative approach to such a platform will now be provided.

In this example, the implementing apparatus 300 comprises an input 302 that operably couples to a processor 301. The input 302 can be configured and arranged to provide a plurality of frames of sampled audio content. Again, there are various known ways by which this can be accomplished that will be readily known and available to a person skilled in the art. The processor 301, in turn, can comprise a dedicated purpose or a partially or wholly programmable platform that is configured and arranged (via, for example, corresponding programming) to effect selected teachings as have been set forth herein. In particular, this processor 301 can be configured and arranged to process the incoming plurality of frames using a speech recognition search process that comprises, at least in part, the aforementioned searching for at least one of subword boundaries and word boundaries as may be contained within each frame less often than on a frame-by-frame basis.

Those skilled in the art will recognize and understand that such an apparatus 300 may be comprised of a plurality of physically distinct elements as is suggested by the illustration shown in FIG. 3. It is also possible, however, to view this illustration as comprising a logical view, in which case one or more of these elements can be enabled and realized via a shared platform. It will also be understood that such a shared platform may comprise a wholly or at least partially programmable platform as are known in the art.

So configured, an implementing platform having only modest processing capabilities (such as a cellular telephone or the like) can nevertheless make highly leveraged use of powerful speech recognition search processes by effectively skipping some frames on a regular basis when searching for subword and/or word boundaries as may be contained within such frames. The described approaches are relatively easy to implement and are also readily scaled to meet the needs and/or opportunities as correspond to a given application setting. For

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

We claim:

1. A method comprising:
providing a plurality of frames of sampled audio content;
processing the plurality of frames using a speech recognition search process
comprising, at least in part, searching for at least two of:
state boundaries;
subword boundaries; and
word boundaries;
using different search resolutions.

2. The method of claim 1 wherein using a speech recognition search process comprises using a hidden Markov model-based speech recognition process.

3. The method of claim 2 wherein processing the plurality of frames using a speech recognition search process comprising, at least in part, searching for at least two of:
state boundaries;
subword boundaries; and
word boundaries;
using different search resolutions comprises, at least in part, processing the plurality of frames using a speech recognition search process comprising, at least in part, searching for each of:
state boundaries;
subword boundaries; and
word boundaries;
using different search resolutions.

4. The method of claim 3 wherein processing the plurality of frames using a speech recognition search process comprising, at least in part, searching for each of:
state boundaries;
subword boundaries; and
word boundaries;
using different search resolutions comprises searching for word boundaries with less search resolution than is used when searching for subword boundaries.

5. The method of claim 1 wherein processing the plurality of frames using a speech recognition search process comprising, at least in part, searching for at least two of:
state boundaries;
subword boundaries; and
word boundaries;
using different search resolutions comprises only searching for subword boundaries for every Nth frame, where N comprises an integer larger than one.

6. The method of claim 5 wherein processing the plurality of frames using a speech recognition search process comprising, at least in part, searching for at least two of:
state boundaries;
subword boundaries; and
word boundaries;
using different search resolutions further comprises only searching for word boundaries for every Mth frame, where M comprises an integer larger than N.

7. The method of claim 6 wherein M comprises an integer that comprises a multiple of N.

8. An apparatus comprising:
an input configured and arranged to receive a plurality of frames of sampled audio content;
processor means operably coupled to the input for processing the plurality of frames using a speech recognition search process comprising, at least in part, searching for at least two of:
state boundaries;
subword boundaries; and
word boundaries;
using different search resolutions.

9. The apparatus of claim 8 wherein the processor means uses a speech recognition search process by using a hidden Markov model-based speech recognition process.

10. The apparatus of claim 9 wherein the processor means is further for processing the plurality of frames using a speech recognition search process comprising, at least in part, searching for each of:
state boundaries;
subword boundaries; and
word boundaries;
using different search resolutions.

11. The apparatus of claim 10 wherein the processor means is further for processing the plurality of frames using a speech recognition search process comprising, at least in part, searching for each of:
state boundaries;
subword boundaries; and
word boundaries;
using different search boundaries by searching for word boundaries with less search resolution than is used when searching for subword boundaries.

12. The apparatus of claim 8 wherein the processor is further for processing the plurality of frames using a speech recognition search process comprising, at least in part, searching for at least two of:
state boundaries;
subword boundaries; and
word boundaries;
using different search resolutions by only searching for subword boundaries for every Nth frame, where N comprises an integer larger than one.

13. The apparatus of claim 12 wherein the processor means is further for processing the plurality of frames using a speech recognition search process comprising, at least in part, searching for at least two of:
state boundaries;
subword boundaries; and
word boundaries;
using different search resolutions by only searching for word boundaries for every Mth frame, where M comprises an integer larger than N.

14. The apparatus of claim 13 wherein M comprises an integer that comprises a multiple of N.

15. An apparatus comprising:
an input configured and arranged to provide a plurality of frames of sampled audio content;
a processor operably coupled to the input and being configured and arranged to process the plurality of frames using a speech recognition search process comprising, at least in part, searching for at least two of:
state boundaries;
subword boundaries; and
word boundaries;
using different search resolutions.

16. The apparatus of claim 15 wherein the processor is further configured and arranged to use a speech recognition search process by using a hidden Markov model-based speech recognition process.

17. The apparatus of claim 16 wherein the processor is further configured and arranged to process the plurality of frames using a speech recognition search process comprising, at least in part, searching for at least two of:
state boundaries;
subword boundaries; and
word boundaries;
using different search resolutions by, at least in part, processing the plurality of frames using a speech recognition search process comprising, at least in part, searching for each of:
state boundaries;
subword boundaries; and
word boundaries;
using different search resolutions.

18. The apparatus of claim 17 wherein the processor is further configured and arranged to process the plurality of frames using a speech recognition search process comprising, at least in part, searching for each of:
state boundaries;
subword boundaries; and
word boundaries;
using different search resolutions by searching for word boundaries using less search resolution than is used when searching for subword boundaries.

19. The apparatus of claim 15 wherein the processor is further configured and arranged to process the plurality of frames using a speech recognition search process comprising, at least in part, searching for at least two of:
state boundaries;
subword boundaries; and
word boundaries;
using different search resolutions by only searching for subword boundaries for every Nth frame, where N comprises an integer larger than one.

20. The apparatus of claim 19 wherein the processor is further configured and arranged to process the plurality of frames using a speech recognition search process comprising, at least in part, searching for at least two of:
state boundaries;
subword boundaries; and
word boundaries;
using different search resolutions by only searching for word boundaries for every Mth frame, where M comprises an integer larger than N.
